(19) United States
(12) Patent Application Publication
(10) Pub. No.: US 2010/0171572 A1
(43) Pub. Date: Jul. 8, 2010

(54) LOW VIBRATION DIELECTRIC RESONANT OSCILLATORS

(75) Inventor: Martin Peter Widgery, Hampshire (GB)

Correspondence Address: PILLSBURY WINTHROP SHAW PITTMAN, LLP, P.O. BOX 10500, MCLEAN, VA, 22102, US

(73) Assignee: BAE SYSTEMS plc, London (GB)

(21) Appl. No.: 12/301,272

(22) PCT Filed: Aug. 5, 2008
(86) PCT No.: PCT/GB2008/050665

§ 371 Date: Aug. 11, 2009

(30) Foreign Application Priority Data
Aug. 31, 2007 (EP) 07253449.8
Aug. 31, 2007 (GB) 0716963.4

(51) Int. Cl. H01P 7/10

(52) U.S. Cl. 333/219.1

(57) ABSTRACT

The present invention relates to low vibration probes. Specifically, the present invention relates to low vibration probes in dielectric resonant oscillators. Accordingly, the present invention provides a dielectric resonant oscillator apparatus comprising a casing; a lid; a puck mounted on a support and one or more probes wherein the support comprises a hollow ceramic tube.

The present invention relates to low vibration dielectric resonant oscillators. Specifically, the present invention relates to a low vibration lid for dielectric resonant oscillators.

Known dielectric resonant oscillator devices operate well in the 10 GHz range, however they are not used in the S-band (˜3 GHz˜) range as the standard design does not work well due to the susceptibility of the known apparatus to vibrations.

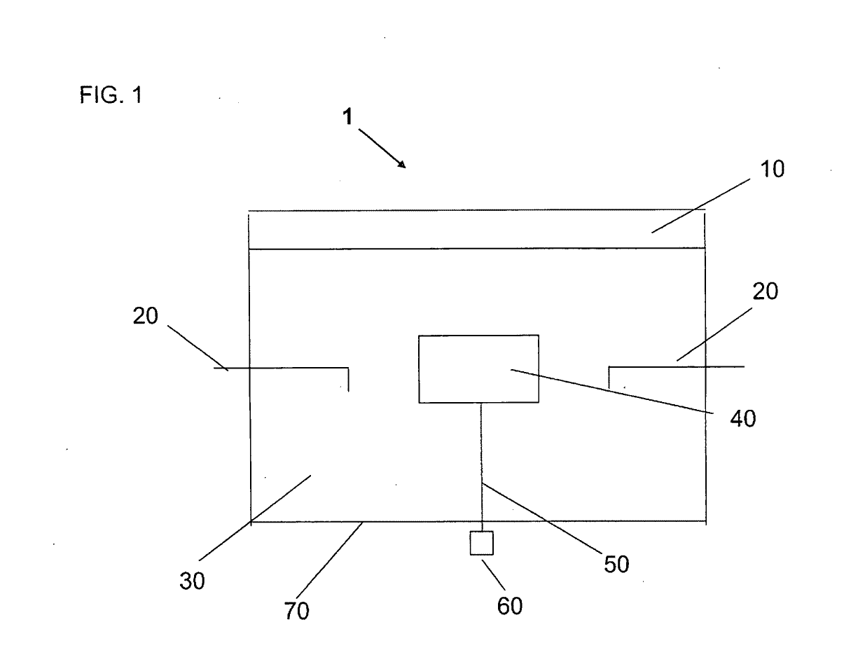

As illustrated in FIG. 1, such a known device 1 would typically comprise a case 70 with a screw-on lid 10. The case 70 and lid 10 define the resonant cavity 30 inside, which has mounted therein a puck (dielectric resonator) 40 on a thin support rod 50 and two probes 20. The thin support rod extends through the bottom of the case 70 and is fastened to the bottom of the outside of the case 70 by a fastener 60, which is typically a bolt. The probes 20 also extend outside the case 70, through the sides of the case, so that they can be wired up to suitable apparatus (not shown) to fulfil their function.

Accordingly, the present invention provides a dielectric resonant oscillator apparatus comprising a casing; a lid; a puck mounted on a support and one or more probes wherein the lid is formed as a lockable turning screw

An advantage of the present invention is that the apparatus is improved sufficiently to be used in the 1 to 4 GHz range by modifying the lid, the puck and the probes.

Specific embodiments of the invention will now be described, by way of example only and with reference to the accompanying drawings that have like reference numerals, wherein:

FIG. 1 is a cross-sectional drawing of a known dielectric oscillator device; and

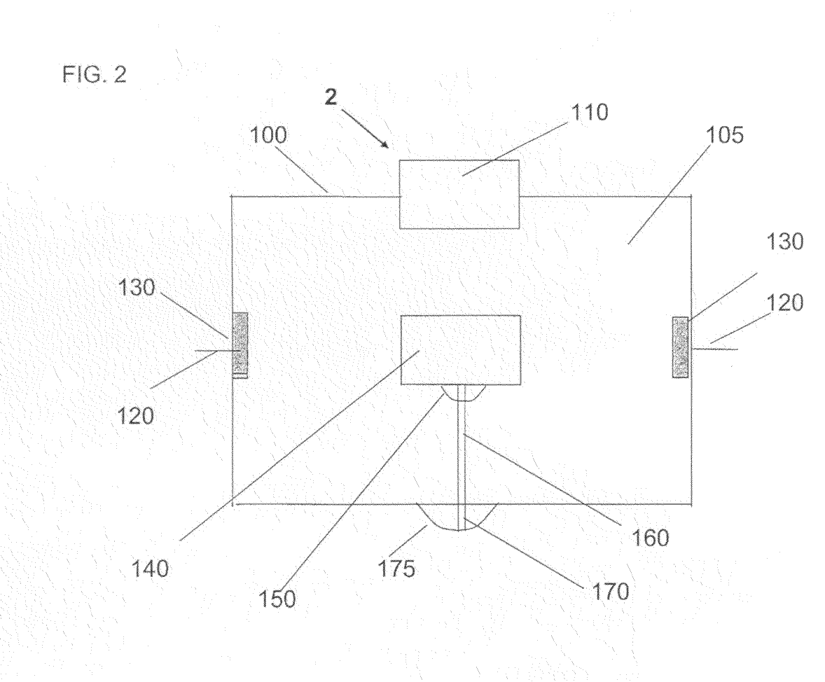

FIG. 2 is a cross-sectional drawing of a dielectric oscillator device according to an embodiment of the present invention.

A specific embodiment of the present invention will now be described with reference to FIG. 2:

A dielectric resonant oscillator 2 according to a specific embodiment of the present invention is shown in FIG. 2. The dielectric resonant oscillator 2 comprises a case 100 with a lockable turning screw 110 defining a resonant cavity 105 inside. Mounted in the resonant cavity 105 is a puck (dielectric oscillator) 140 on a hollow ceramic tubular support 160. The hollow ceramic tubular support 160 is mounted in a recess 175 in the bottom of the case 100 and fixed in place by ceramic paste 170 that fills the recess 175. The hollow ceramic tubular support 160 is also fixed to the bottom of the puck 140 using ceramic paste 150. The two probes 130 are formed on printed circuit boards which conform to the curvature of the inside of the wall of the case 100 and which have wires 120 extending though the wall of the case 100 to the apparatus (now shown) connected to the probes 130.

Use of a hollow tubular ceramic resonator support 160 allows for a wider support base and provides increased rigidity. The support 160 is mounted in a specially designed recess 175 at the base of the cavity 105, which is filled with ceramic paste 170 to glue the support 160 in place, which also contributes to increased rigidity and increases the “gluing area”.

Use of printed circuit boards conforming to the shape of the inside of the cylindrical resonant cavity 105 overcomes the vibration risk of the known electrical probes in FIG. 1, which were just wires poking through holes in the cylinder and into the resonant cavity. The PCBs are glued to the sides of the resonant cavity to prevent movement.

The lockable tuning screw 110 allows for very fine adjustment of the volume of the cavity.

Alternatively, the cavity 105 can be filled with dielectric foam instead of being hollow. This would also mean that the probes 130 need not be glued in place, as they would be held in place by the dielectric foam.

Further, as another alternative, the cylinder that forms the case 100 can be made from a single piece of metal as this would improve heat distribution and further decrease vibrations.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A dielectric resonant oscillator apparatus comprising a casing; a lid; a puck mounted on a support and one or more probes wherein the lid is formed as a lockable turning screw.

2. An apparatus according to claim 1, wherein the support is fixed to the puck using ceramic paste.

3. An apparatus according to claim 1, wherein the support is fixed to the casing using ceramic paste.

4. An apparatus according to claim 1, wherein the casing is filled with dielectric foam.

5. An apparatus according to claim 1, wherein the casing is formed from a single piece of metal.

6. An apparatus according to claim 2, wherein the support is fixed to the casing using ceramic paste.

7. An apparatus according to claim 2, wherein the casing is filled with dielectric foam.

8. An apparatus according to claim 3, wherein the casing is filled with dielectric foam.

9. An apparatus according to claim 2, wherein the casing is formed from a single piece of metal.

10. An apparatus according to claim 3, wherein the casing is formed from a single piece of metal.

11. An apparatus according to claim 4, wherein the casing is formed from a single piece of metal.
